(19) United States
(12) Patent Application Publication
(10) Pub. No.: US 2024/0214873 A1
(43) Pub. Date: Jun. 27, 2024

(54) SERVICE TYPE INDICATOR IN USER ASSISTANCE INFORMATION MESSAGING

(71) Applicant: T-Mobile USA, Inc., Bellevue, WA (US)

(72) Inventors: Kun Lu, Bellevue, WA (US); Egil Gronstad, Encinitas, CA (US); Jun Liu, Issaquah, WA (US); Lin Zhang, Overland Park, KS (US)

(21) Appl. No.: 18/146,594

(22) Filed: Dec. 27, 2022

(51) Int. Cl. H04W 28/20; H04W 72/04; H04W 76/10

(52) U.S. Cl. CPC H04W 28/20; H04W 72/04; H04W 76/10

(57) ABSTRACT

A user equipment (UE) configured to provide a service type indicator in a user assistance information (UAI) message to a base station of a telecommunication network is described herein. The service type indicator indicates a type of a network-using service active on the UE. A base station, as also described herein, then takes action based on resources available to the base station and on the service type indicator received from the UE in the UAI message.

### BACKGROUND

Base stations, such as fifth generation (5G) gNodeBs (gNB), are not informed by user equipment (UEs) of the services requested by the UEs for transmission over their frequency bands. Before the base stations receive any sort of identification of those services from the core network, significant signaling takes place among core network nodes. Base stations thus are delayed in their ability to adjust their resource handling based on the requested services, even when such services cannot be supported by resources available to the base stations. Both supportable and unsupportable requests will still result in a core network associated with the base stations setting up the necessary connections for the services, even though the base stations' subsequent failure to support the services will result in those core network connections going unused. Also, the attempts to support the services may result in other services supported by the base stations being negatively impacted.

Advances in technology that support ever greater and faster consumption and exchange of data are leading to newer services, such as extended reality (XR) services. Such XR services may be associated with or include augmented reality (AR), virtual reality (VR), etc. These new services may consume substantial network resources and impact the functioning of some base stations.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a network environment in which a base station takes action based on resources available to the base station and on a service type indicator received from a UE in a user assistance information (UAI) message sent from the UE to the base station.

FIG. 2 shows a sequence diagram of a general example sequence of messages corresponding to transmission of a UAI message from a UE to a base station and taking action, by the base station, based on a service type indicator received from the UE in the UAI message.

FIG. 3 shows an example of a system architecture for the UE.

FIG. 4 shows an example of a system architecture for the base station.

FIG. 5 shows a flowchart of an example method in which the UE can provide a service type indicator in a UAI message to a base station of a telecommunication network.

FIG. 6 shows a flowchart of an example method in which the base station can take action based on resources available to the base station and on the service type indicator received from the UE in the UAI message.

### DETAILED DESCRIPTION

This disclosure describes a UE configured to provide a service type indicator to a base station in a UAI message and a base station configured to receive such a message and take action based on resources available to the base station and on the service type indicator. Some services, such as XR services, may consume a large amount of a base station's resources, and may even consume more resources than a base station has available. Providing the base station with knowledge about the service, then, is important to ensuring effective resource management. The UE makes the base station aware of the service by using a service type indicator field of a UAI message, a message which is sent after an initial radio resource control (RRC) connection request and response but before any RRC reconfiguration of the UE by the base station. Such timing may allow the base station receiving the UAI message to take action to manage resources before, e.g., resources of a core network or application servers are allocated. The base station may adapt network traffic associated with the service to a lower resolution, deny the request for the service from the UE, or handover the UE to a different base station or access point. On the other hand, if sufficient resources are available, the base station may proceed with a protocol data unit (PDU) session and RRC reconfiguration to enable initiation of the service to the UE over the telecommunication network.

In some implementations, the UE may also provide multiple service type indicators, desired traffic characteristics, or both, and the base station may evaluate which action to take based on resources of the base station and that additional information. For example, while a service type indicator and available resources may result in the base station adapting network traffic, addition of another service type indicator or traffic characteristics could result in a different action, such as denial of service or a handover.

As used herein, a “user assistance information” message includes messages meeting the 3GPP definition of “user assistance information” messages, as well as other messages sent from the UE to the base station during an RRC_CONNECTED state but before RRC reconfiguration.

“Service” includes XR services and any other current and future services, such as those consuming significant resources of base stations.

### Example Environment

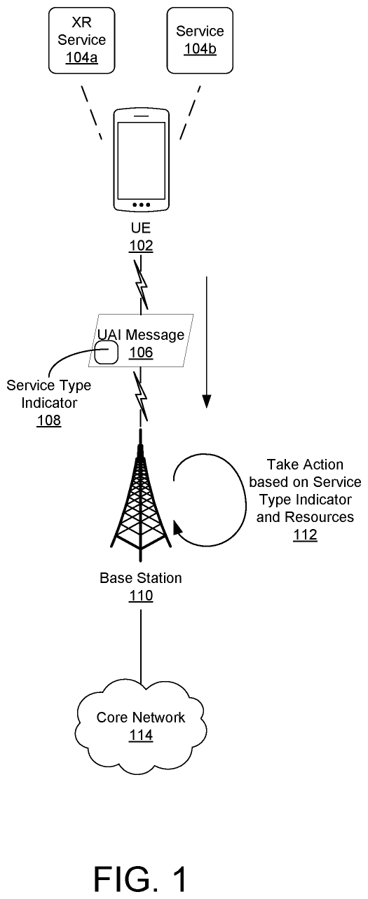

FIG. 1 shows an example of a network environment in which a base station takes action based on resources available to the base station and on a service type indicator received from a UE in a user assistance information (UAI) message sent from the UE to the base station. As illustrated, a UE 102 may have an XR service 104a or other service 104b (hereinafter also referred to as “service 104”) activated and, in response, may send a UAI message 106 including a service type indictor 108 for the service 104 to a base station 110. Based on the service type indicator 108 and available resources, the base station 110 may, at 112, take action. Such an action could be adaptation of network traffic, denial of service, a handover, or proceeding with a connection, including continuing a set-up for the connection with the core network 114.

In various implementations, the UE 102 can be any device that can wirelessly connect to the base station 110 and execute services, such as services 104, that utilize a telecommunication network. In some examples, the UE 102 can be a mobile phone, such as a smart phone or other cellular phone. In other examples, the UE 102 can be a personal digital assistant (PDA), a media player, a tablet computer, a gaming device, a smart watch, a hotspot, an Internet of Things (IoT) device, a wearable device, an XR device, an AR/VR device, a personal computer (PC) such as a laptop, desktop, or workstation, or any other type of computing or communication device.

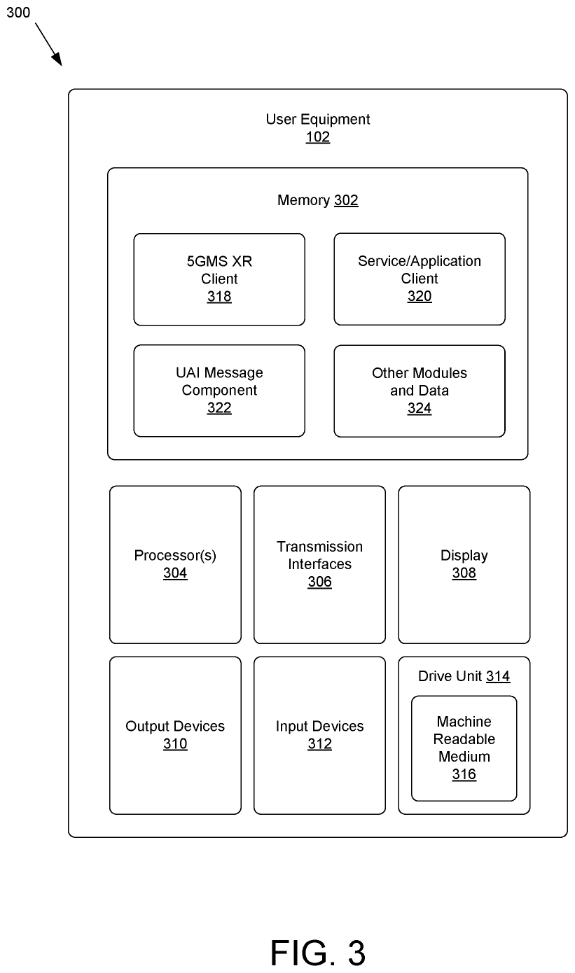

The UE 102 may be configured with a platform and applications/services (such as services 104) enabling the UE 102 to engage in any of a number of services, such as a voice calling service, a video calling service, a messaging service, a video streaming service, a data browsing service, a video conferencing service, a security camera service, an XR service, or an AR/VR service. The UE 102 may include a 5G media streaming service (5GMS) XR client, clients for the services 104, and a UAI management component. The UE 102 may also include a transmission interface, including at least a radio and supporting software, for transmitting and receiving communications with the base station 110. An example system architecture of a UE 102 is shown in FIG. 3 and described herein in detail with respect to that figure.

In some implementations, the base station 110 can be part of an access network of a telecommunication network, such as a radio access network (RAN). The telecommunication network can also have the core network 114 linked to the access network. The UE 102 can wirelessly connect to the base station 110 of the access network, and in turn be connected to the core network 114 via the base station 110. The core network 114 can also link the UE 102 to an Internet Protocol (IP) Multimedia Subsystem (IMS), the Internet, and/or other networks.

The UE 102 and elements of the telecommunication network, such as the base station 110, other elements of the access network, and/or the core network 114, can be compatible with one or more radio access technologies, wireless access technologies, protocols, and/or standards. For example, the UE 102, the base station 110, and/or the core network 114 can support 5G new radio (NR) technology, Long-Term Evolution (LTE)/LTE Advanced technology, High-Speed Data Packet Access (HSDPA)/Evolved High-Speed Packet Access (HSPA+) technology, other fourth generation (4G) technology, Universal Mobile Telecommunications System (UMTS) technology, Code Division Multiple Access (CDMA) technology, Global System for Mobile Communications (GSM) technology, WiMax® technology, WiFi® technology, and/or any other previous or future generation of radio access technology.

As an example, the base station 110 can be a gNodeB (gNB) of a 5G access network. As another example, the access network can be an LTE access network, known as an Evolved UMTS Terrestrial Radio Access Network (E-UTRAN), and the base station 110 can be an evolved Node B (eNB) of the LTE access network. The core network 114 can also be based on LTE or 5G. For instance, the core network 114 can be a 5G core network or an LTE packet core network known as an Evolved Packet Core (EPC). The base station 110 and the core network 114 may be based on the same radio access technology, or different radio access technologies. For instance, in some examples the base station 110 can be a 5G gNB that is linked to an LTE core network and/or a 5G core network.

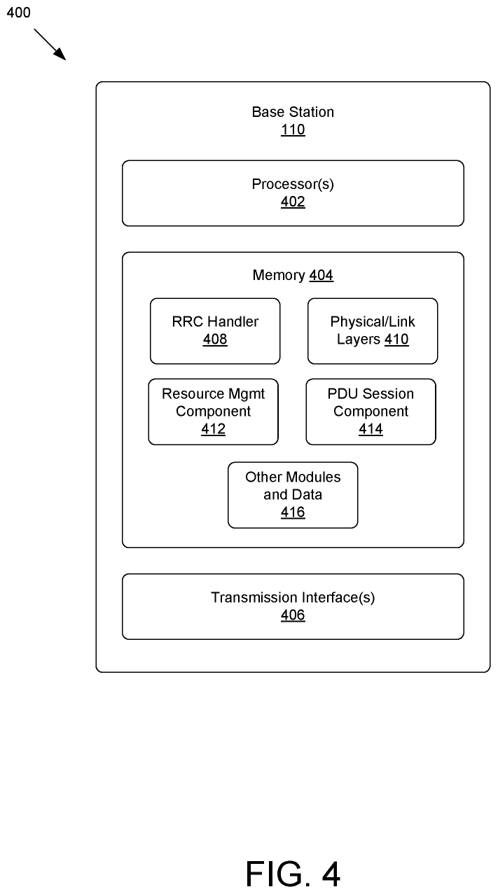

The base station 110 also includes one or more radio antennas, a transmission interface, a scheduler, an RRC handler, physical/link layers, a resource management component, and a PDU session component. The base station 110 may also include any other logic or components that base stations may be equipped/configured with. An example of a base station 110 is illustrated in FIG. 4 and described herein with reference to that figure.

As noted, the core network 114 may be an EPC and can include nodes such as a Home Subscriber Server (HSS), Mobility Management Entity (MME), and Policy and Charging Rules Function (PCRF). Alternatively, the core network 114 may be a 5G core network can includes nodes such as a Unified Data Management (UDM) node, an Access and Mobility Management Function (AMF), and a Policy Control Function (PCF). The core network 114 can include an IMS or be connected to one and further includes gateway devices for access to external networks, such as the Internet, and external services.

To establish wireless connectivity to the base station 110, before any session associated with the service 104 has begun, the UE 102 may send an RRC connection request to the base station 110 and receive a response, resulting in the UE 102 transitioning from an RRC_IDLE status to an RRC_CONNECTED status. While in the RRC_CONNECTED status, the UE 102 and base station 110 may proceed to establish a PDU session for a service 104 across the telecommunication network. The base station 110 may also update any settings for the UE 102 with an RRC reconfiguration message. If the UE 102 moves out of range of the base station 110 it may be handed over to another base station or access point or dropped.

In various implementations, the UE 102 includes a client of a XR service 104a, a client of a different service 104a, or both. Such a client communicates with a remote server of its respective service 104, over the telecommunication network, and accordingly requires wireless resources, power resources, computation resources, etc. from devices of the telecommunication network for its service 104 to function. An XR service 104a may require significant resources, such as bandwidth allocations or power/compute resources, beyond those available on some base stations. Other services 104b may also require significant resources, both current services and those which may emerge in the future. In some examples, a client of a service 104 may also specify desired traffic characteristics, such as desired uplink or downlink, for providing the service 104.

In some implementations, a client of the service 104 or 5GMS XR client may by triggered by activation of the service 104 and, in response, either form and send a UAI message 106 or invoke a UAI message component of the UE 102 to form and send the UAI message 106. In some circumstances, the forming and sending may be conditional based on a base station type. If a base station is of a type known to have sufficient resources for the service 104, a configuration may be deployed to the UE 102 which specifies that no UAI message need be sent when the service 104 is activated.

The UAI message 106 may include other fields typically included in a UAI message, such as those defined in 3GPP specifications, as well as a service type indicator 108 for the service 104. If only one service 104 (e.g., XR service 104a) is of concern to the operator of the telecommunication network, the service type indicator 108 may simply be a flag or bit indicating activation. In other examples, the service type indicator 108 may be specified in a manner similar to other parameters specified in a UAI message 106. Also, as noted above, the UAI message 106 may also specify traffic characteristics, such as desire uplink and downlink, for the service 104. A UAI message 106 may be sent any time a value included in a UAI message changes, so activation of the service 104 triggers formation and sending of the UAI message 106.

An example of a UAI message without a service type indicator 108 or traffic characteristics—a UAI message as has been specified by the 3GPP, can be found in 3GPP TS 38.331 V17.0.0 (2022-03) in section 6.2.2.

In some implementations, multiple services 104 may trigger the need to send a UAI message 106 with a service type indicator 108. In such cases, the UE 102 may send a UAI message 106 that includes multiple service type indicators 108.

In various implementations, once the UE 102 has sent the UAI message 106 to the base station 110, the base station 110 receives the UAI message 106 and an RRC handler of the base station 110 determines whether the UAI message 106 includes a service type indicator 108, multiple service type indicators 108, traffic characteristics, etc. Upon determining that the UAI message 106 includes a service type indicator 108, the RRC handler communicates with lower layers (e.g., the physical/link layers) to determine resources available to the base station 110. As noted herein, such resources can include available frequencies, power consumption resources, compute resources, etc. Upon receiving an answer from the lower layers, the RRC handler of the base station determines what action to take based on the service type indicator(s) 108, traffic characteristics (if included in the UAI message 106), and the available resources. Such a determination may be made based on a configurable ruleset/set of priorities. The base station 110 then takes action at 112.

If the RRC handler determines that the resources are sufficient, then the RRC handler and other base station 110 components proceed with the PDU session, at 112, communicating with the core network 114 to establish connections among nodes of the core network 114 in support of the service 104, allocating frequency resources and other base station resources, and communicating any further information needed to the UE 102 to enable the use of the service 104 over the telecommunication network.

If the RRC handler determines that the resources are not sufficient, it may adapt the network traffic (e.g., send traffic associated with the service 104 at a lower resolution), deny a request associated with the service 104, or perform a handover of the connection between the base station 110 and UE 102 to another base station or access point. In some examples, the identity of the handover recipient base station/access point may depend on a type of the base station/access point or a type of spectrum/band supported by the base station/access point.

### Example Messages

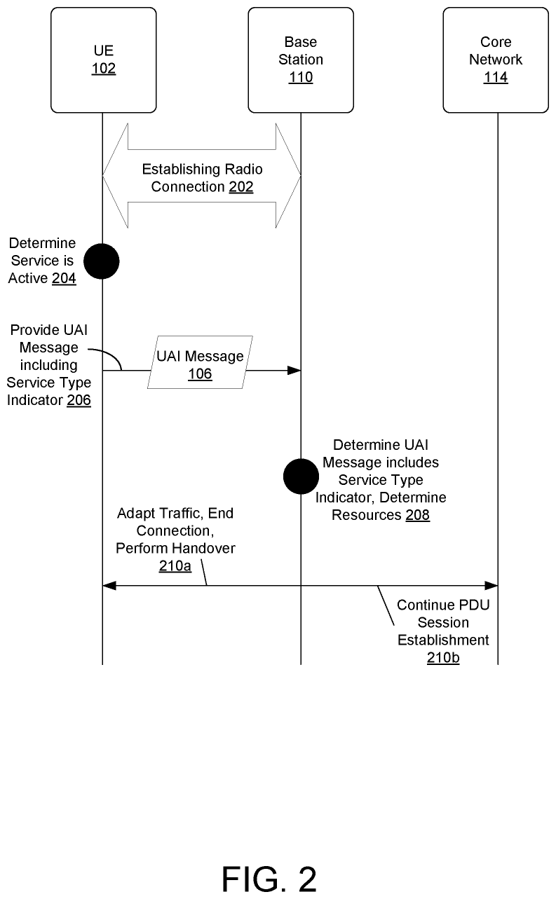

FIG. 2 shows a sequence diagram of a general example sequence of messages corresponding to transmission of a UAI message from a UE to a base station and taking action, by the base station, based on a service type indicator received from the UE in the UAI message. As shown in FIG. 2, the UE 102 and base station 110 may exchange messages to establish a radio network connection between the UE 102 and base station 110. These messages and connections are shown in arrow 202, which gives, as an example, RRC communications for establishing a radio link.

Operations are also shown in FIG. 2, aligned as black dots with the lines proceeding from the devices performing the operations. At 204, the operation of determining that a service is active is performed by the UE 102.

Based on the determining operation at 204, the UE sends, at 206 a UAI message 106 to the base station 110. And as shown, the UAI message 106 includes a service type indicator 108 for the service determined to be active.

At 208, the operations of determining that the UAI message 106 includes a service type indicator 108 and determining the resources available to the base station 110 are performed by the base station 110.

Based on the service type indicator 108 and the resources, the base station 110 performs actions resulting in communications 210a or communications 210b. Communications 210a, to the UE 102, may result in or be associated with adaptation of network traffic, denial of a service request, or a handover. Communications 210b, to the core network 114, may result in or be associated with continued setup of the PDU session associated with the service that is active on the UE 102.

### Example Architectures

FIG. 3 shows an example of a system architecture 300 for a UE, such as UE 102. The UE 102 can have at least one memory 302, processor(s) 304, one or more transmission interfaces 306, a display 308, output devices 310, input devices 312, and/or a drive unit 314 including a machine readable medium 316.

In various examples, the memory 302 can include system memory, which may be volatile (such as RAM), non-volatile (such as ROM, flash memory, etc.) or some combination of the two. The memory 302 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information and which can be accessed by the UE 102. Any such non-transitory computer-readable media may be part of the UE 102.

The memory 302 can include one or more software or firmware elements, such as computer-readable instructions that are executable by the one or more processors 304. For example, the memory 302 can store computer-executable instructions associated with a 5GMS XR client 318, a service/application client 320, and a UAI message component 322. As described herein, the 5GMS XR client 318 may be a client of an XR service 104a or associated with such an XR service 104a, may detect activation of the XR service 104a, may form a UAI message 106 including a service type identifier 108 for the XR service 104a, and transmit the UAI message 106. A service/application client 320 may be a client of a service 104, as described herein, and a UAI message component 322 may form and transmit UAI messages 106. Such a UAI message component 322 may be a subcomponent of the 5GMS XR client 318 and/or the service/application client 320 or may be a separate component. The memory 302 can also store other modules and data 324, which can be utilized by the UE 102 to perform or enable performing any action taken by the UE 102. The other modules and data 324 can include a UE platform, operating system, and applications, and data utilized by the platform, operating system, and applications.

In various examples, the processor(s) 304 can be a CPU, a graphics processing unit (GPU), or both CPU and GPU, or any other type of processing unit. Each of the one or more processor(s) 304 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 304 may also be responsible for executing all computer applications stored in the memory 302, which can be associated with types of volatile (RAM) and/or nonvolatile (ROM) memory.

The transmission interfaces 306 can include transceivers, modems, interfaces, antennas, and/or other components that perform or assist in exchanging RF communications with base stations, such as base station 110, a Wi-Fi access point, or otherwise implement connections with one or more networks. The transmission interfaces 306 can be compatible with one or more radio access technologies, such as 5G NR radio access technologies and/or LTE radio access technologies. The transmission interfaces 306 can also be used by the base station 110 to send and receive messages, such as those described with respect to FIG. 2, and to perform operations, such as those described with respect to FIG. 4.

The display 308 can be a liquid crystal display or any other type of display commonly used in UEs. For example, the display 308 may be a touch-sensitive display screen and can thus also act as an input device or keypad, such as for providing a soft-key keyboard, navigation buttons, or any other type of input.

The output devices 310 can include any sort of output devices known in the art, such as the display 308, speakers, a vibrating mechanism, and/or a tactile feedback mechanism. Output devices 310 can also include ports for one or more peripheral devices, such as headphones, peripheral speakers, and/or a peripheral display.

The input devices 312 can include any sort of input devices known in the art. For example, input devices 312 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 316 of a drive unit 314 can store one or more sets of instructions, such as software or firmware, that embodies any one or more of the methodologies or functions described herein. The instructions can also reside, completely or at least partially, within the memory 302, processor(s) 304, and/or transmission interface(s) 306 during execution thereof by the UE 102.

FIG. 4 shows an example of a system architecture 400 for the base station 110, in accordance with various examples. The base station 110 can be a 5G gNB, an LTE eNB, or other type of base station as described above. As shown, the base station 110 can include processor(s) 402, memory 404, and transmission interfaces 406.

The processor(s) 402 may be a central processing unit (CPU), or any other type of processing unit. Each of the one or more processor(s) 402 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 402 may also be responsible for executing all computer-executable instructions and/or computer applications stored in the memory 404.

In various examples, the memory 404 can include system memory, which may be volatile (such as RAM), non-volatile (such as ROM, flash memory, etc.) or some combination of the two. The memory 404 can also include additional data storage devices (removable and/or non-removable) such as, for example, magnetic disks, optical disks, or tape. Memory 404 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, DVD, or other optical storage, magnetic cassettes, magnetic tape, magnetic disk storage or other magnetic storage devices, or any other non-transitory medium which can be used to store the desired information and which can be accessed by the base station 110. Any such non-transitory computer-readable media may be part of the base station 110.

The memory 404 can store computer-readable instructions and/or other data associated with operations of the base station 110. For example, the memory 404 can store computer-readable instructions and/or other data associated with a RRC handler 408, physical/link layers 410, a resource management component 412, and a PDU session component 414. The RRC handler 408, as described above, may determine whether a UAI message includes a service type identifier, communicate with the physical/link layers 410 to identify available resources, and take action based on the resources and service type identifier. Such action may include invoking, e.g. a resource management component 412, which may be part of the RRC handler 408 or a separate component, and which may cause the base station 110 to adapt network traffic, deny a service request, or hand over connectivity to another base station or access point. The action could also involve proceeding with a PDU session, which may be accomplished by a PDU session component 414. The PDU session component 414 may also be part of RRC handler 408 or a separate component. The memory 404 can also store other modules and data 416. The other modules and data 416 can be utilized by the base station 110 to perform or enable performing any action taken by the base station 110. The other modules and data 416 can include a scheduler to allocate frequency resources to a UE, such as UE 102, a platform, operating system, firmware, and/or applications, and data utilized by the platform, operating system, firmware, and/or applications.

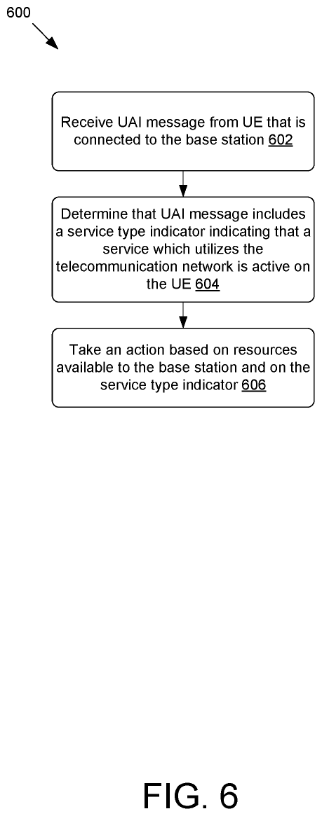

The transmission interfaces 406 can include one or more modems, receivers, transmitters, antennas, error correction units, symbol coders and decoders, processors, chips, application specific integrated circuits (ASICs), programmable circuit (e.g., field programmable gate arrays), firmware components, and/or other components that can establish connections with the UE 102, other base stations or RAN elements, elements of the core network 114, and/or other network elements, and can transmit data over such connections. For example, the transmission interfaces 406 can establish a connection with the UE 102 over an air interface. The transmission interfaces 406 can also support transmissions using one or more radio access technologies, such as 5G NR. The transmission interfaces 406 can also be used by the base station 110 to send and receive messages, such as those described with respect to FIG. 2, and to perform operations, such as those described with respect to FIG. 6.

### Example Operations

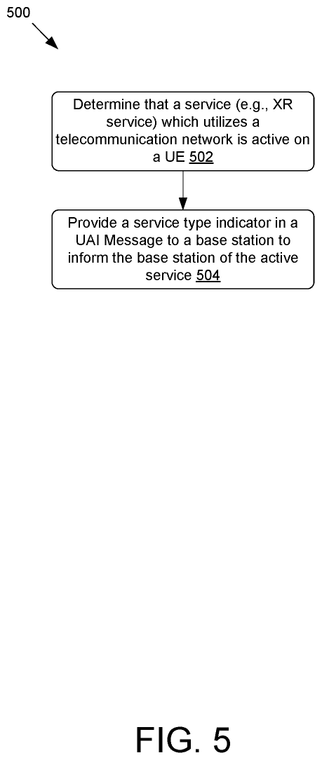

FIGS. 5 and 6 illustrate example processes. These processes are each illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 5 shows a flowchart of an example method in which the UE can provide a service type indicator in a UAI message to a base station of a telecommunication network. At 502, the UE determines that a service which utilizes a telecommunication network is active on the UE. In some implementations, the service may be an XR service.

At 504, the UE provides a service type indicator in a UAI message to a base station of the telecommunication network. The service type indicator indicates a type of the service, such as an XR service type when the service is an XR service. In some implementations, providing the service type indicator in the UAI message comprises providing multiple service type indicators for multiple services that are active on the UE. Also or instead, providing the service type indicator includes providing, in a traffic characteristics field of the UAI message, indication(s) of desired uplink or downlink bandwidth. In further implementations, the determining and the providing may be performed in response to an activation of the service on the UE. Also, the providing may be performed conditionally based on a base station type of the base station. Additionally, the providing may be performed after transmission from the UE of a RRC connection request and before receiving an RRC reconfiguration message.

FIG. 6 shows a flowchart of an example method in which the base station can take action based on resources available to the base station and on the service type indicator received from the UE in the UAI message. At 602, a base station receives a UAI message from a UE that is connected to that base station.

At 604, the base station determines that the UAI message includes a service type indicator indicating that a service which utilizes a telecommunication network is active on the UE. In some examples, the service is an XR service and the service type indicator indicates that the service is an XR service.

At 606, the base station takes an action based on resources available to the base station and on the service type indicator. Taking the action may include a RRC handler of the base station communicating with a lower layer of a communication stack to determine if the resources available to the base station are sufficient for the service. In some implementations, taking the action includes determining that insufficient resources are available to the base station and either terminating a connection with the UE or handing the UE off to another base station or wireless access point. In further implementations, taking the action includes determining that sufficient resources are available to the base station and proceeding with establishing a PDU session between the UE and a core network of the telecommunication network to use for the service. In additional examples, the action includes adaptation of network traffic between the UE and the base station for lower resolution service.

In some examples, the receiving, at 602, comprises receiving multiple service type indicators for multiple services that are active on the UE, the determining, at 604, comprises determining that the UAI message includes the multiple service type indicators, and the taking the action, at 606, comprises taking the action based on the resources and on the multiple service type indicators.

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A user equipment (UE) comprising:
a processor; and
a plurality of programming instructions that, when executed by the processor, perform operations including:
determining that a service which utilizes a telecommunication network is active on the UE; and
providing a service type indicator in a user assistance information (UAI) message to a base station of the telecommunication network, the service type indicator indicating a type of the service.

2. The UE of claim 1, wherein the service is an extended reality (XR) service and the service type indicator indicates that the service is an XR service.

3. The UE of claim 1, wherein providing the service type indicator in the UAI message comprises providing multiple service type indicators for multiple services that are active on the UE.

4. The UE of claim 1, wherein the providing includes providing, in a traffic characteristics field of the UAI message, indication(s) of desired uplink or downlink bandwidth.

5. The UE of claim 1, wherein the determining and the providing are in response to an activation of the service on the UE.

6. The UE of claim 1, wherein the providing is performed after transmission from the UE of a radio resource control (RRC) connection request and before receiving an RRC reconfiguration message.

7. The UE of claim 1, wherein the providing is performed conditionally based on a base station type of the base station.

8. A method comprising:
receiving, by a base station connected to a user equipment (UE), a user assistance information (UAI) message;
determining, by the base station, that the UAI message includes a service type indicator indicating that a service which utilizes a telecommunication network is active on the UE; and
taking an action, by the base station, based on resources available to the base station and on the service type indicator.

9. The method of claim 8, wherein the service is an extended reality (XR) service and the service type indicator indicates that the service is an XR service.

10. The method of claim 8, wherein the receiving comprises receiving multiple service type indicators for multiple services that are active on the UE, the determining comprises determining that the UAI message includes the received multiple service type indicators, and the taking the action comprises taking the action based on the resources and on the multiple service type indicators.

11. The method of claim 8, wherein the determining comprises determining that the UAI message includes traffic characteristics indicating desired uplink or downlink bandwidth for the UE and taking the action comprises taking the action based on the resources, the service type indicator, and the traffic characteristics.

12. The method of claim 8, wherein the taking the action includes determining that insufficient resources are available to the base station and the action is one of terminating a connection with the UE or handing the UE off to another base station or wireless access point.

13. The method of claim 8, wherein the taking the action includes determining that sufficient resources are available to the base station and the action is proceeding with establishing a protocol data unit (PDU) session between the UE and a core network of the telecommunication network to use for the service.

14. The method of claim 8, wherein the action includes adaptation of network traffic between the UE and the base station for lower resolution service.

15. The method of claim 8, wherein the taking the action includes a radio resource control (RRC) handler of the base station communicating with a lower layer of a communication stack to determine if the resources available to the base station are sufficient for the service.

16. A non-transitory computer storage medium having a plurality of programming instructions stored thereon that, when executed by a user equipment (UE), cause the UE to perform operations comprising:
determining that an extended reality (XR) service which utilizes a telecommunication network is active on the UE; and
providing a service type indicator in a user assistance information (UAI) message to a base station of the telecommunication network, the service type indicator indicating that the XR service is active on the UE.

17. The non-transitory computer storage medium of claim 16, wherein providing the service type indicator in the UAI message comprises providing multiple service type indicators for multiple services that are active on the UE.

18. The non-transitory computer storage medium of claim 16, wherein the providing includes providing, in a traffic characteristics field of the UAI message, indication(s) of desired uplink or downlink bandwidth.

19. The non-transitory computer storage medium of claim 16, wherein the determining and the providing are in response to an activation of the XR service on the UE.

20. The non-transitory computer storage medium of claim 16, wherein the providing is performed conditionally based on a base station type of the base station.
